(19) United States
(12) Patent Application Publication
(10) Pub. No.: US 2025/0350087 A1
(43) Pub. Date: Nov. 13, 2025

(54) OPTICAL PATH COUPLING SYSTEM AND CONTROL METHOD FOR OPTICAL PATH COUPLING SYSTEM

(71) Applicant: WuHan Raycus Fiber Laser Technologies CO., LTD, Wuhan, Hubei (CN)

(72) Inventors: Yan YAO, Wuhan, Hubei (CN); Mingfeng LIU, Wuhan, Hubei (CN); Guopeng YAN, Wuhan, Hubei (CN); Xiao NIE, Wuhan, Hubei (CN); Suqi XIA, Wuhan, Hubei (CN); Faping WANG, Wuhan, Hubei (CN); Dapeng YAN, Wuhan, Hubei (CN)

(73) Assignee: WuHan Raycus Fiber Laser Technologies CO., LTD, Wuhan, Hubei (CN)

(21) Appl. No.: 18/879,818

(22) PCT Filed: Nov. 2, 2023
(86) PCT No.: PCT/CN2023/129199

§ 371 Date: Dec. 30, 2024

(30) Foreign Application Priority Data
Mar. 23, 2023 (CN) 202310290458.4

(51) Int. Cl. H01S 3/13

(52) U.S. Cl. CPC H01S 3/1305

(57) ABSTRACT

Embodiments of the present application disclose an optical path coupling system and a control method for an optical path coupling system. The optical path coupling system comprises a laser input optical fiber, an optical path switching module, an optical path coupling module and a monitoring control module, wherein the optical path switching module comprises first photoelectric sensors, and the optical path coupling module comprises second photoelectric sensors. According to the present application, the monitoring control module outputs a first alarm signal according to one or both of a first signal and a second signal, so that the safety of the optical path coupling system can be improved.

### TECHNICAL FIELD

The present application relates to the technical field of laser technology, and in particular to an optical path coupling system and a control method for the optical path coupling system.

### BACKGROUND

In the industrial field, with the continuous development of laser technology, laser processing has gradually replaced traditional industrial manufacturing methods such as cutting, welding, cladding. It has the characteristics of high production efficiency, more processing materials, high precision and flexible operation. Fiber lasers use glass optical fibers doped with rare earth elements as gain media. They have the advantages of good beam quality, high conversion efficiency, good heat dissipation characteristics, and high reliability. They are one of the mainstream light sources for laser processing. Since the optical path coupling system of the fiber laser is a closed system as a whole, its internal state needs to be monitored to ensure safety during use. However, there are not enough existing safety monitoring methods for the optical path coupling system, resulting in poor overall safety of the optical path coupling system.

### SUMMARY

The embodiments of the present application provide an optical path coupling system and a control method for the optical path coupling system, which can solve the problem of poor safety of the existing optical path coupling system.

The present application provides an optical path coupling system, comprising:
a laser input optical fiber, configured to transmit a laser beam;
an optical path switching module, located in an output optical path of the laser beam; wherein the optical path switching module comprises an optical path switching assembly and at least one first photoelectric sensor, and wherein the optical path switching assembly is configured to reflect the laser beam to form a reflected light beam and a first scattered light, the at least one first photoelectric sensor is configured to monitor an intensity of the first scattered light and output a first signal according to the intensity of the first scattered light;
an optical path coupling module, located in an output optical path of the reflected light beam; wherein the optical path coupling module comprises a coupling assembly and a second photoelectric sensor, and wherein the coupling assembly is configured to couple the reflected light beam to form a coupled light beam and a second scattered light, the second photoelectric sensor is configured to monitor an intensity of the second scattered light and output a second signal according to the intensity of the second scattered light; and
a monitoring control module, electrically connected to the at least one first photoelectric sensor and the second photoelectric sensor; wherein the monitoring control module is configured to receive the first signal and the second signal and output a first alarm signal according to the first signal and/or the second signal.

Optionally, in some embodiments of the present application, the monitoring control module is configured to receive the first signal and compare a voltage value of the first signal with a first preset threshold, and when the voltage value of the first signal is greater than or equal to the first preset threshold, the monitoring control module outputs the first alarm signal; and/or,
wherein the monitoring control module is configured to receive the second signal and compare a voltage value of the second signal with a second preset threshold, and when the voltage value of the second signal is greater than or equal to the second preset threshold, the monitoring control module outputs the first alarm signal;
wherein the second preset threshold is greater than or equal to the first preset threshold.

Optionally, in some embodiments of the present application, the monitoring control module is used to receive the second signal, and when the voltage value of the second signal is greater than or equal to the second preset threshold, and the voltage value of the second signal continues to increase, the monitoring control module outputs the first alarm signal.

Optionally, in some embodiments of the present application, the monitoring control module is configured to receive the second signal and compare the voltage value of the second signal with a first saturation threshold, and when the voltage value of the second signal is equal to the first saturation threshold, the monitoring control module outputs the first alarm signal; wherein the first saturation threshold is greater than the second preset threshold.

Optionally, in some embodiments of the present application, the first preset threshold is less than or equal to 2.0V; and the second preset threshold is greater than or equal to 2.5V and less than or equal to 3.0V.

Optionally, in some embodiments of the present application, the optical path switching assembly comprises a plurality of rotatable reflectors and a plurality of rotating adjustment components, wherein the plurality of rotatable reflectors are sequentially arranged along the output optical path of the laser beam, and the rotating adjustment components are each connected to one of the rotatable reflectors to rotate the corresponding rotatable reflector into or out of the output optical path of the laser beam.

Optionally, in some embodiments of the present application, each of the rotatable reflectors is provided with one of the at least one first photoelectric sensor to monitor the intensity of the first scattered light generated after the laser beam is reflected by a corresponding one of the rotatable reflectors.

Optionally, in some embodiments of the present application, the optical path coupling system further comprises a shaping module located between the laser input optical fiber and the optical path switching module; the shaping module comprising a shaping component and a third photoelectric sensor, wherein the laser beam is shaped by the shaping component to form a shaped beam and a third scattered light, and the third photoelectric sensor is configured to monitor an intensity of the third scattered light and output a third signal according to the intensity of the third scattered light; the monitoring control module is electrically connected to the third photoelectric sensor, and the monitoring control module is configured to receive the third signal and output the first alarm signal according to the third signal.

Optionally, in some embodiments of the present application, the shaping component comprises one or more of a collimating lens, a beam expander lens or a shaping lens.

Optionally, in some embodiments of the present application, the monitoring control module is configured to receive the third signal and compare a voltage value of the third signal with a third preset threshold, and when the voltage value of the third signal is greater than or equal to the third preset threshold, the monitoring control module outputs the first alarm signal; wherein the third preset threshold is less than or equal to the second preset threshold.

Optionally, in some embodiments of the present application, the third preset threshold is less than or equal to 2.0V.

Optionally, in some embodiments of the present application, the optical path coupling system further comprises:
a laser output optical fiber, located in an output optical path of the coupled light beam;
an operation module, located in an output optical path of the laser output optical fiber, wherein the coupled light beam is to be transmitted to the operation module through the laser output optical fiber; the operation module comprises a control switch configured to output a fourth signal; the monitoring control module is electrically connected to the control switch and configured to receive the fourth signal and control an emission of the laser beam according to the fourth signal.

Optionally, in some embodiments of the present application, the optical path coupling system comprises a first contact sensor and a second contact sensor, wherein the first contact sensor is configured to monitor whether the laser input optical fiber is correctly connected and a temperature of the laser input optical fiber, and the second contact sensor is configured to monitor whether the laser output optical fiber is correctly connected and a temperature of the laser output optical fiber; the monitoring control module is electrically connected to the first contact sensor and the second contact sensor, and the monitoring control module is configured to receive monitoring signals of the first contact sensor and the second contact sensor and control the emission of the laser beam according to the monitoring signals.

Optionally, in some embodiments of the present application, the optical path coupling system comprises an absorber arranged in parallel with the plurality of rotatable reflectors and configured to absorb the laser beam.

Optionally, in some embodiments of the present application, a temperature sensor is provided on the absorber, and the temperature sensor is configured to monitor a temperature of the absorber and output a temperature signal; the monitoring control module is electrically connected to the temperature sensor and configured to receive the temperature signal and output a second alarm signal according to the temperature signal.

Optionally, in some embodiments of the present application, the optical path coupling system comprises a circulating cooling module, on which a flow rate and temperature sensor is provided, wherein the flow rate and temperature sensor is configured to monitor a flow rate and temperature of water at an inlet of the circulating cooling module, the monitoring control module is electrically connected to the flow rate and temperature sensor, the monitoring control module is configured to receive a monitoring signal of the flow rate and temperature sensor and control the circulating cooling module to cool circulating water according to the monitoring signal.

Optionally, in some embodiments of the present application, the optical path coupling system further comprises a humidity sensor located in the optical path switching module, wherein the humidity sensor is configured to monitor a humidity in the optical path switching module and output a humidity signal, wherein the monitoring control module is electrically connected to the humidity sensor and configured to receive the humidity signal and control the optical path switching module to perform dehumidification processing according to the humidity signal.

Accordingly, embodiments of the present application further provides a control method for an optical path coupling system, wherein the optical path coupling system comprises a laser input optical fiber, and an optical path switching module and an optical path coupling module sequentially arranged along a transmission path of the laser input optical fiber; the optical path switching module comprising an optical path switching assembly and a first photoelectric sensor, the optical path coupling module comprising a coupling assembly and a second photoelectric sensor, the optical path coupling system further comprising a monitoring control module electrically connected to the optical path switching assembly, the first photoelectric sensor and the second photoelectric sensor; wherein the control method comprises:
detecting the optical path coupling system to determine whether the optical path coupling system meets a light emission condition;
if the optical path coupling system meets the light emission condition, using the monitoring control module to control the optical path switching assembly to switch to a transmission path of a laser beam, so that the laser beam is transmitted to the optical path switching assembly through the laser input optical fiber, and is reflected by the optical path switching assembly to form a reflected beam and a first scattered light, and the reflected beam is coupled by the coupling assembly to form a coupled beam and a second scattered light;
using the first photoelectric sensor to monitor an intensity of the first scattered light and output a first signal according to the intensity of the first scattered light;
using the second photoelectric sensor to monitor an intensity of the second scattered light and output a second signal according to the intensity of the second scattered light;
using the monitoring control module to receive the first signal and compare a voltage value of the first signal with a first preset threshold, and using the monitoring control module to output a first alarm signal if the voltage value of the first signal is greater than or equal to the first preset threshold; and/or using the monitoring control module to receive the second signal and compare a voltage value of the second signal with a second preset threshold, and using the monitoring control module to output a first alarm signal if the voltage value of the second signal is greater than or equal to the second preset threshold.

Optionally, in some embodiments of the present application, using the monitoring control module to receive the second signal and compare a voltage value of the second signal with a second preset threshold comprises:
using the monitoring control module to receive the second signal;
comparing the voltage value of the second signal with the second preset threshold, and determining whether the voltage value of the second signal continues to increase;
if the voltage value of the second signal is greater than or equal to the second preset threshold, and the voltage value of the second signal continues to increase, using the monitoring control module to output the first alarm.

Optionally, in some embodiments of the present application, using the monitoring control module to receive the second signal and compare a voltage value of the second signal with a second preset threshold comprises:
using the monitoring control module to receive the second signal;
comparing the voltage value of the second signal with the second preset threshold and a first saturation threshold;
if the voltage value of the second signal is greater than the second preset threshold, and the voltage value of the second signal is equal to the first saturation threshold, using the monitoring control module to output the first alarm.

### BENEFICIAL EFFECTS

The optical path coupling system according to the embodiments of the present application includes a laser input optical fiber, and an optical path switching module and an optical path coupling module arranged in sequence along the transmission path of the laser input optical fiber. The optical path switching module includes an optical path switching assembly and a first photoelectric sensor. The optical path coupling module includes a coupling assembly and a second photoelectric sensor. The optical path coupling system also includes a monitoring control module, which is electrically connected to the optical path switching assembly, the first photoelectric sensor, and the second photoelectric sensor. According to the present application, both the first photoelectric sensor is provided in the optical path switching module, and a second photoelectric sensor is provided in the optical path coupling module, so that the monitoring control module can output a first alarm signal based on one or both of the first signal output by the first photoelectric sensor and the second signal output by the second photoelectric sensor, thereby helping to improve the safety of the optical path coupling system.

### BRIEF DESCRIPTION OF THE DRAWINGS

In order to more clearly illustrate the technical solutions in the embodiments of the present application, the drawings required for use in the description of the embodiments will be briefly introduced below. Obviously, the drawings described below are only some embodiments of the present application. For those skilled in the art, other drawings can be obtained based on these drawings without inventive work.

FIG. 1 is a schematic diagram showing the structure of an optical path coupling system provided in according to an embodiment of the present application.

FIG. 2 is a flow chart of a control method for an optical path coupling system according to an embodiment of the present application.

FIG. 3 is a flow chart of step S500 in FIG. 2 according to an embodiment of the present application.

FIG. 4 is another flowchart of step S500 in FIG. 2 according to an embodiment of the present application.

### DETAILED DESCRIPTION OF THE EMBODIMENTS

The technical solutions in the embodiments of the present application will be clearly and completely described below in conjunction with the drawings in the embodiments of the present application. Obviously, the described embodiments are only part of the embodiments of the present application, rather than all the embodiments.

Based on the embodiments in this application, all other embodiments obtained by those skilled in the art without making any inventive work shall fall within the scope of protection of this application. In addition, it should be understood that the specific embodiments described herein are only used to illustrate and explain the present application, and are not used to limit the present application. In the present application, unless otherwise specified, directional words such as “upper” and “lower” generally refer to the upper and lower parts of the device in actual use or working state, specifically in the direction shown in the accompanying drawings; while “inside” and “outside” are relative to the outline of the device.

The embodiments of the present application provide an optical path coupling system and a control method for the optical path coupling system, which are described in detail below. It should be noted that the description order of the following embodiments is not intended to limit the preferred order of the embodiments.

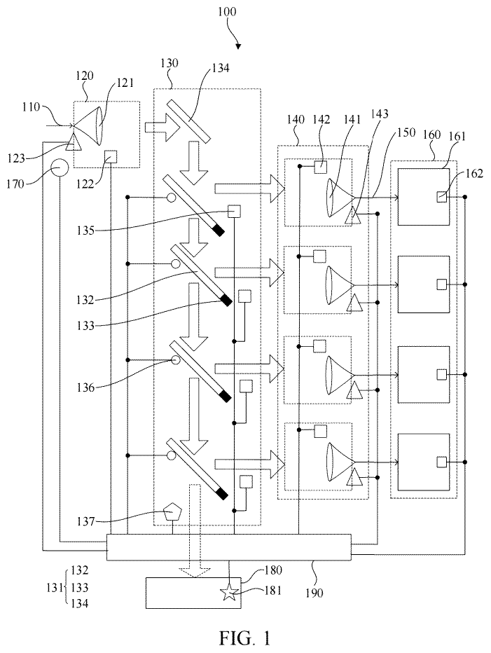

First, an embodiment of the present application provides an optical path coupling system. As shown in FIG. 1, the optical path coupling system 100 includes a laser input optical fiber 110. The laser input optical fiber 110 is configured to transmit a laser beam, so that the laser beam enters the optical path coupling system 100 through the laser input optical fiber, and then the laser beam is processed by the optical path structure in the optical path coupling system 100.

The optical path coupling system 100 includes an optical path switching module 130, which is located in the output optical path of the laser beam. The optical path switching module 130 includes an optical path switching assembly 131 and a first photoelectric sensor 135. The optical path switching assembly 131 is configured to reflect the laser beam to form a reflected light beam and a first scattered light. The first photoelectric sensor 135 is configured to monitor the intensity of the first scattered light and output a first signal according to the intensity of the first scattered light.

The optical path switching assembly 131 includes a rotatable reflector 132 and a rotating adjustment component 133. The rotating adjustment component 133 is connected to the rotatable reflector 132 to rotate the rotatable reflector 132 into or out of the transmission path of the laser beam. When the rotatable reflector 132 is rotated into the transmission path of the laser beam, the transmission path of the laser beam is formed, so that the laser beam can be reflected by the rotatable reflector 132.

During actual use, due to the influence of the processing technology of the rotatable reflector 132 or the damage of the rotatable reflector 132 due to long-term use, the laser beam may generate a first scattered light when it is reflected by the rotatable reflector 132, thereby reducing the final coupling efficiency of the laser beam. Moreover, the first scattered light generated will also cause damage to other components in the optical path switching assembly 131, affecting the service life of the entire optical path coupling system 100.

By using the first photoelectric sensor 135 to monitor the intensity of the first scattered light, the damage condition of the rotatable reflector 132 can be reversely indicated. The greater the intensity of the first scattered light, the more serious the damage to the rotatable reflector 132. The first photoelectric sensor 135 can output a corresponding first signal according to the intensity of the first scattered light, and timely replace or adjust the rotatable reflector 132 to ensure the normal use of the optical path coupling system 100 and improve the service life of the optical path coupling system 100.

In some embodiments, the optical path switching assembly 131 includes a plurality of rotatable reflectors 132 and a plurality of rotating adjustment components 133. The plurality of rotatable reflectors 132 are arranged in sequence along the output optical path of the laser beam. The rotating adjustment components 133 are connected to the rotatable reflectors 132 one by one to rotate the corresponding rotatable reflectors 132 into or out of the transmission path of the laser beam. When one of the rotatable reflectors 132 is rotated into the transmission path of the laser beam, it can cut off and reflect the laser beam, and the other rotatable reflectors 132 are rotated out of the transmission path of the laser beam. By selecting the rotatable reflector 132 to be rotated into the transmission path, the reflected optical path of the laser beam can be adjusted to meet different usage requirements.

A first photoelectric sensor 135 is correspondingly disposed for each rotatable reflector 132 to monitor the intensity of the first scattered light generated after the laser beam is reflected by the corresponding rotatable reflector 132. Since the plurality of rotatable reflectors 132 are located in the same chamber, the first scattered light generated by any rotatable reflector 132 is located in the chamber. That is to say, no matter which rotatable reflector 132 is rotated into the transmission path of the laser beam, each first photoelectric sensor 135 can monitor the intensity of the first scattered light and output a corresponding first signal.

It should be noted that the optical path switching assembly 131 further includes a fixed reflector 134, which is disposed between the laser input optical fiber 110 and the rotatable reflector 132 to change the transmission direction of the laser beam. By providing the fixed reflector 134 for changing the transmission direction of the laser beam, the overall structure and optical path layout of the optical path coupling system 100 can be adjusted accordingly to meet different design requirements. The specific arrangement and quantity can be adjusted according to the actual optical path design requirements, and there is no special restriction here.

The optical path coupling system 100 includes an optical path coupling module 140, which is located in the output optical paths of the reflected light beams. The optical path coupling module 140 includes a coupling assembly 141 and a second photoelectric sensor 142. The coupling assembly 141 is configured to couple the corresponding reflected light beam to form a coupled light beam and a second scattered light. The second photoelectric sensor 142 is configured to monitor the intensity of the second scattered light and output a second signal according to the intensity of the second scattered light.

The coupling assembly 141 includes a coupling cylinder, a coupling lens located in the coupling cylinder, and an optical fiber adapter connected to one end of the coupling cylinder. The optical fiber adapter is configured to connect to the laser output optical fiber 150. The reflected light beam enters from one end of the coupling cylinder and is coupled by the coupling lens in the coupling cylinder to form a coupled light beam whose focusing point is located at the end face of the laser output optical fiber 150, and then is coupled into the laser output optical fiber 150 and transmitted.

During actual use, due to the influence of the coupling lens processing technology or the damage of the coupling lens due to long-term use, the reflected light beam may generate a second scattered light after being coupled by the coupling lens, thereby reducing the final coupling efficiency of the laser beam. Moreover, the second scattered light generated will also cause damage to other components in the coupling assembly 141, affecting the service life of the entire optical path coupling system 100.

By using the second photoelectric sensor 142 to monitor the intensity of the first scattered light, the damage of the coupling lens can be reversely indicated. The greater the intensity of the second scattered light, the more serious the damage of the coupling lens. The second photoelectric sensor 142 can output a corresponding second signal according to the intensity of the second scattered light, so as to replace or adjust the coupling lens in time to ensure the normal use of the optical path coupling system 100 and improve the service life of the optical path coupling system 100.

In some embodiments, the optical path coupling module 140 includes a plurality of coupling assemblies 141 each arranged in correspondence with one of the rotatable reflectors 132 in the optical path switching assembly 131. When one of the rotatable reflectors 132 is rotated into the transmission path of the laser beam, the laser beam is reflected by the rotatable reflector 132 to form a reflected beam, and then coupled by the corresponding coupling assembly 141 to form a coupled beam. By selecting the rotatable reflector 132 to be rotated in the transmission path, the corresponding coupling assembly 141 can be selected to meet different usage requirements.

A corresponding second photoelectric sensor 142 is provided for each coupling assembly 141 to monitor the intensity of the second scattered light generated after the reflected light beam is coupled by the coupling lens of the corresponding coupling assembly 141. Since the second photoelectric sensor 142 is located in the coupling cylinder of the corresponding coupling assembly 141, the second scattered light generated after coupling by the coupling lens is also located only in the corresponding coupling cylinder. Therefore, the second photoelectric sensor 142 is configured to monitor the intensity of the second scattered light in the corresponding coupling cylinder only and output the corresponding second signal.

The optical path coupling system 100 includes a monitoring control module 190, which is electrically connected to the first photoelectric sensor 135 and the second photoelectric sensor 142. The monitoring control module 190 is configured to receive the first signal and the second signal, and output a first alarm signal according to the first signal and/or the second signal to indicate that a fault or safety hazard occurs in the optical path coupling system 100 at this time.

The first photoelectric sensor 135 and the second photoelectric sensor 142 are configured to monitor the intensity of the first scattered light and the second scattered light respectively, and convert the intensity of the first scattered light and the intensity of the second scattered light into voltage signals respectively, and then output the corresponding voltage signals as the first signal and the second signal to the monitoring control module 190. The monitoring control module 190 can receive the first signal and the second signal, and output a first alarm signal according to the first signal and/or the second signal and the set determination condition.

It should be noted that one of the reasons why the final coupling efficiency of the optical path coupling system 100 is reduced is mainly due to the arrangement of and loss caused by the rotatable reflector 132 in the optical path switching assembly 131 and the arrangement of and loss caused by the coupling lens in the coupling assembly 141. The laser beam passing through the rotatable reflector 132 and the coupling lens may generate a certain amount of scattered light. By providing the first photoelectric sensor 135 in the optical path switching module 130 and providing the second photoelectric sensor 142 in the optical path coupling module 140, the monitoring control module 190 can output an alarm signal based on one or both of the first signal and the second signal, thereby helping to improve the safety monitoring in the optical path coupling system 100 and improve the safety of the optical path coupling system 100.

In some embodiments, the monitoring control module 190 is configured to receive a first signal and compare the voltage value of the first signal with a first preset threshold. When the voltage value of the first signal is greater than or equal to the first preset threshold, the monitoring control module 190 outputs a first alarm signal.

During the use of the optical path coupling system 100, the first photoelectric sensor 135 monitors the intensity of the first scattered light in real time, and transmits the first signal to the monitoring control module 190 in real time. Since the first signal directly reflects the scattering of the laser beam reflected by the rotatable reflector 132, as long as the voltage value of the first signal is greater than or equal to the first preset threshold, the monitoring control module 190 outputs a first alarm signal, thereby stopping the output of the laser beam.

In other embodiments, the monitoring control module 190 is configured to receive a second signal and compare the voltage value of the second signal with a second preset threshold. When the voltage value of the second signal is greater than or equal to the second preset threshold, the monitoring control module 190 outputs a first alarm signal. The second photoelectric sensor 142 is configured to monitor the intensity of the second scattered light in real time, and transmit a second signal to the monitoring control module 190 in real time.

During the use of the optical path coupling system 100, in addition to the scattered light generated by the coupling assembly 141 itself, the retro-reflected light which is generated due to reflection from the surface of the processed workpiece and enters the coupling cylinder when the coupled light beam is transmitted to the surface of the workpiece through the laser output optical fiber 150 will also be monitored by the second photoelectric sensor 142 as part of the second scattered light. That is to say, the generation of retro-reflected light will increase the intensity of the second scattered light monitored by the second photoelectric sensor 142, but in this case, the increased intensity of the second scattered light cannot directly indicate that the coupling efficiency of the optical path coupling system 100 has been significantly reduced. Therefore, when setting the second preset threshold, the second preset threshold can be set to be greater than the first preset threshold to reduce the impact of the generation of back reflection light on the accuracy of the first alarm signal output by the monitoring control module 190.

It should be noted that when the processed workpiece does not produce obvious retro-reflected light, that is, when the second scattered light is mainly generated by the coupling assembly 141 itself, the second preset threshold can be set to be equal to the first preset threshold, so that the monitoring control module 190 can output the first alarm signal in time, thereby stopping the output of the laser beam. That is to say, the magnitude relationship between the second preset threshold and the first preset threshold can be adjusted accordingly according to the actual use of the optical path coupling system 100, and no special limitation is made here.

The first preset threshold can be set to be less than or equal to 2.0V; the second preset threshold can be set to be greater than or equal to 2.5V and less than or equal to 3.0V. Specifically, the first preset threshold can be set to 2.0V, 1.8V, 1.6V or 1.5V, etc.; the second preset threshold can be set to 2.5V, 2.6V, 2.8V or 3.0V, etc. The corresponding specific values can be selected according to the actual use of the optical path coupling system 100, and no special restrictions are made here.

In some embodiments, the monitoring control module 190 is configured to receive a second signal. When the voltage value of the second signal is greater than or equal to a second preset threshold and the voltage value of the second signal continues to increase, the monitoring control module 190 outputs a first alarm signal. That is to say, when the monitoring control module 190 outputs the first alarm signal, it needs to simultaneously determine whether the voltage value of the second signal is greater than or equal to the second preset threshold, and whether the voltage value of the second signal is continuously increasing.

During the use of the optical path coupling system 100, the coupled light beam may be reflected on the surface of the workpiece to generate retro-reflected light and enter the coupling cylinder. The generation of retro-reflected light will increase the intensity of the second scattered light monitored by the second photoelectric sensor 142, causing the voltage value of the second signal to be greater than or equal to the second preset threshold. However, the intensity of the reflected light generated on the workpiece surface during the machining process is not stable, which causes the voltage value of the second signal to fluctuate.

In the case that the second scattered light detected by the second photoelectric sensor 142 is mainly caused by damage to the coupling lens itself, since the damage is irreversible and the second scattered light will cause further damage to the coupling lens, the intensity of the second scattered light will further increase, thereby causing the voltage value of the second signal to continue to increase. By combining the voltage value of the second signal and the growth pattern of the voltage value of the second signal to determine whether the coupling efficiency of the optical path coupling system 100 decreases, the accuracy of the first alarm signal output by the monitoring control module 190 can be improved, thereby improving the stability of the optical path coupling system 100 during use.

In other embodiments, the monitoring control module 190 is configured to receive the second signal and compare the voltage value of the second signal with the first saturation threshold. When the voltage value of the second signal is equal to the first saturation threshold, the monitoring control module 190 outputs a first alarm signal. The first saturation threshold is greater than the second preset threshold.

When the second scattered light detected by the second photoelectric sensor 142 is mainly caused by damage to the coupling lens itself, the continuous increase in the intensity of the second scattered light may cause the voltage value of the second signal to rapidly increase to the first saturation threshold in a short time. In this case, if the monitoring control module 190 cannot determine whether the voltage value of the second signal is continuously increasing or fluctuating, it can output a first alarm signal based on the voltage value of the second signal reaching the first saturation threshold, so as to achieve safety monitoring of the optical path coupling system 100, thereby improving the safety of the optical path coupling system 100 during use.

It should be noted that if the intensity of the second scattered light generated by the coupling lens itself is small, but the reflection of the coupled light beam by the workpiece surface is strong, so that the intensity of the retro-reflected light generated is large, the voltage value of the second signal exceeds the second preset threshold and reaches the second saturation threshold, and remains at the second saturation threshold, wherein the second saturation threshold is less than the first saturation threshold. In this case, the monitoring control module 190 will not output the first alarm signal.

Since the coupled light beam will experience certain losses after being reflected on the workpiece surface, the intensity of the retro-reflected light generated is lower than the intensity of the coupled light beam. Compared with the scattered light directly generated by the coupled light beam, the voltage value of the second signal corresponding to the retro-reflected light is smaller, so that the second saturation threshold to which the voltage value of the second signal caused by the retro-reflected light reaches is lower than the first saturation threshold to which the voltage value of the second signal caused by the scattered light reaches.

That is to say, when the voltage value of the second signal of the optical path coupling system 100 reaches saturation due to the coupling lens itself, its saturation value is the first saturation threshold, and the monitoring control module 190 will output the first alarm signal; and when the voltage value of the second signal of the optical path coupling system 100 reaches saturation due to retro reflection, its saturation value is the second saturation threshold, and the monitoring control module 190 will not output the first alarm signal.

Optionally, the optical path coupling system 100 further includes a shaping module 120 located between the laser input optical fiber 110 and the optical path switching module 130. The shaping module 120 includes a shaping component 121 and a third photoelectric sensor 122. The shaping component 121 is configured to shape the laser beam to form a shaped beam and a third scattered light. The third photoelectric sensor 122 is configured to monitor the intensity of the third scattered light and output a third signal according to the intensity of the third scattered light. The monitoring control module 190 is electrically connected to the third photoelectric sensor 122, and is used to receive the third signal and output a first alarm signal according to the third signal.

The shaping component 121 includes one or more of a collimating lens, a beam expander lens or a shaping lens to shape the laser beam transmitted by the laser input optical fiber 110 into a target beam, which is then transmitted to the optical path switching module 130 and the optical path coupling module 140 in sequence.

During actual use, due to the influence of the processing technology of the shaping component 121 or the damage of the shaping component 121 due to long-term use, the laser beam may generate third scattered light after being shaped by the shaping component 121, thereby reducing the final coupling efficiency of the laser beam. Moreover, the generated third scattered light will also cause the shaping component 121 to continue to be damaged, affecting the service life of the entire optical path coupling system 100.

By using the third photoelectric sensor 122 to monitor the intensity of the third scattered light, the damage of the shaping component 121 can be reversely indicated. The greater the intensity of the third scattered light, the more serious the damage of the shaping component 121. The third photoelectric sensor 122 can output a corresponding third signal according to the intensity of the third scattered light, and the monitoring control module 190 can output a first alarm signal according to the received third signal, so as to replace or adjust the shaping component 121 in time to ensure the normal use of the optical path coupling system 100 and improve the service life of the optical path coupling system 100.

In some embodiments, the monitoring control module 190 is configured to receive a third signal and compare the voltage value of the third signal with a third preset threshold. When the voltage value of the third signal is greater than or equal to the third preset threshold, the monitoring control module 190 outputs a first alarm signal. During the use of the optical path coupling system 100, the third photoelectric sensor 122 monitors the intensity of the third scattered light in real time, and transmits the third signal to the monitoring control module 190 in real time. Since the third signal directly reflects the scattering of the laser beam shaped by the shaping component 121, as long as the voltage value of the third signal is greater than or equal to the third preset threshold, the monitoring control module 190 outputs the first alarm signal, thereby stopping the output of the laser beam.

The retro-reflected light generated on the surface of the workpiece will not be transmitted to the third photoelectric sensor 122, that is, the retro-reflected light will not affect the voltage value of the third signal. Therefore, when setting the third preset threshold, the third preset threshold can be set to be smaller than the second preset threshold to ensure the accuracy of the first alarm signal output by the monitoring control module 190.

It should be noted that when the processed workpiece does not produce obvious retro-reflected light, that is, when the second scattered light is mainly generated by the coupling assembly 141 itself, the third preset threshold can also be set to be equal to the second preset threshold, so that the monitoring control module 190 can output the first alarm signal in time, thereby stopping the output of the laser beam. That is to say, the magnitude relationship between the third preset threshold and the second preset threshold can be adjusted accordingly according to the actual use of the optical path coupling system 100, and no special limitation is made here.

In some embodiments, when the third preset threshold is set, the third preset threshold can also be set to be equal to the first preset threshold. The third preset threshold can be set to be less than or equal to 2.0V. Specifically, the third preset threshold can be set to 2.0V, 1.8V, 1.6V or 1.5V, etc. The corresponding specific value can be selected according to the actual use of the optical path coupling system 100, and there is no special limitation here.

Optionally, the optical path coupling system 100 also includes a laser output optical fiber 150 and an operation module 160. The laser output optical fiber 150 is located in the output optical path of the coupled light beam, and the operation module 160 is located in the output optical path of the laser output optical fiber 150. The coupled light beam is coupled into the laser output optical fiber 150 from the end face of the laser output optical fiber 150, and then transmitted to the operation module 160 to process the workpiece. The operation module 160 includes a control switch 162 configured to output a fourth signal. The monitoring control module 190 is electrically connected to the control switch 162. The monitoring control module 190 is configured to receive the fourth signal and control the emission of the laser beam according to the fourth signal.

The operation module 160 includes an operation chamber 161. When the optical path coupling system 100 is in use, the workpiece to be processed is placed in the operation chamber 161. To ensure safety during the processing, the operation chamber 161 needs to be kept closed during processing, and the control switch 162 is configured to detect whether the operation chamber 161 is closed. In actual use, when the operation chamber 161 is closed, the control switch 162 is turned on and outputs the fourth signal to the monitoring control module 190. At this time, the monitoring control module 190 controls the emission of the laser beam. If the operation chamber 161 is not closed, it means that the operation module 160 is not ready, then the control switch 162 will not be turned on, and the fourth signal cannot be output. If the monitoring control module 190 does not receive the fourth signal, the laser beam will not be emitted, thereby avoiding safety accidents caused by leakage of the laser beam from the operation chamber 161.

In some embodiments, the operation module 160 includes a plurality of operation chambers 161 each arranged in correspondence with one of the coupling assemblies 141. Each coupling assembly 141 is connected to a laser output optical fiber 150, that is, the operation chambers 161 are each arranged in correspondence with one of the laser output optical fibers 150. When one of the rotatable reflectors 132 of the optical path switching assembly 131 is rotated into the transmission path of the laser beam, the laser beam is reflected by the rotatable reflector 132 to form a reflected beam, and then coupled by the corresponding coupling assembly 141 to form a coupled beam. The coupled beam is coupled into the corresponding laser output optical fiber 150 and transmitted to the corresponding operation chamber 161 by the laser output optical fiber 150. By selecting the rotatable reflector 132 to be rotated into the transmission path, the corresponding coupling assembly 141 can be selected, thereby enabling the selection of the operation chamber 161 to meet different processing requirements.

Each operation chamber 161 is provided with a corresponding control switch 162 to monitor the closing state of the corresponding operation chamber 161 to ensure that when the laser beam is transmitted to the corresponding operation chamber 161, no safety accident occurs due to light leakage in the operation chamber 161.

It should be noted that, during the light emitting process of the optical path coupling system 100, if the operation chamber 161 is opened, that is, the corresponding control switch 162 is turned off, and the monitoring control module 190 cannot receive the fourth signal in real time, the laser beam will also be immediately turned off to ensure the safety of the optical path coupling system 100 and the operator.

Optionally, the optical path coupling system 100 in the embodiment of the present application includes a first contact sensor 123 arranged at a laser input port. The laser input port is configured to connect to the laser input optical fiber 110 in a plug-in manner, and the first contact sensor 123 is configured to monitor whether the laser input optical fiber 110 is correctly connected and the temperature of the laser input optical fiber 110. Correspondingly, the optical path coupling system 100 also includes a second contact sensor 143 arranged at the laser output port configured for the laser output optical fiber 150 to be inserted in, and the second contact sensor 143 is configured to monitor whether the laser output optical fiber 150 is correctly connected and the temperature of the laser output optical fiber 150.

The first contact sensor 123 and the second contact sensor 143 are electrically connected to the monitoring control module 190. When the first contact sensor 123 detects that the laser input optical fiber 110 is correctly connected and the temperature is normal, and the second contact sensor 143 detects that the laser output optical fiber 150 is correctly connected and the temperature is normal, the monitoring control module 190 will allow the laser beam to be emitted. If any of them is abnormal, the laser beam will not be emitted or will be cut off immediately.

In some embodiments, the optical path switching module 130 further includes a position sensor 136, which is disposed corresponding to the rotatable reflector 132 in the optical path switching assembly 131 to monitor whether the corresponding rotatable reflector 132 rotates to a target position. When the optical path switching assembly 131 includes a plurality of rotatable reflectors 132, each rotatable reflector 132 is correspondingly provided with a position sensor 136.

The position sensor 136 is electrically connected to the monitoring control module 190. During the use of the optical path coupling system 100, when one of the rotatable reflectors 132 rotates into the transmission path of the laser beam, the corresponding position sensor 136 monitors the in-position signal of the rotatable reflector 132 and outputs the in-position signal to the monitoring control module 190. The monitoring control module 190 will allow the laser beam to be emitted only after receiving the corresponding in-position signal, otherwise no light will be emitted.

In some other embodiments, the optical path coupling system 100 further includes an absorber 180 arranged in parallel with the plurality of rotatable reflectors 132. During the use of the optical path coupling system 100, when the selected rotatable reflector 132 has not rotated to the target position, that is, the rotatable reflector 132 has not rotated into place, the rotatable reflector 132 cannot cut off or reflect the laser beam, or, when the rotatable reflector 132 is damaged and the optical path is changed, the laser beam will be directly emitted to the absorber 180, and the absorber 180 can absorb the laser beam to avoid light leakage and safety hazards.

The absorber 180 is provided with a temperature sensor 181 electrically connected to the monitoring control module 190. When the absorber 180 absorbs the laser beam, the temperature of the absorber 180 will gradually increase. The temperature sensor 181 is configured to monitor the temperature of the absorber 180 and transmit the monitored temperature information to the monitoring control module 190. When the temperature information received by the monitoring control module 190 reaches a preset temperature threshold, the monitoring control module 190 outputs a second alarm signal and immediately cuts off the emission of light to ensure the safe use of the optical path coupling system 100.

Optionally, the optical path coupling system 100 is also provided with a circulating cooling module for cooling the optical path coupling system 100 to prevent the temperature of the optical path coupling system 100 from continuing to rise during use, thereby ensuring the safe use of the optical path coupling system 100 and improving the service life of the optical path coupling system 100.

The circulating cooling module is provided with a flow and temperature sensor 170 electrically connected to the monitoring control module 190. The flow rate and temperature sensor 170 is configured to monitor the flow rate and temperature of water at the inlet of the circulating cooling module, and transmit the signal about the monitored flow rate and temperature to the monitoring control module 190. During the use of the optical path coupling system 100, the water flow rate can be set to within the target range. When the water temperature signal received by the monitoring control module 190 exceeds the preset temperature threshold, the monitoring control module 190 can control the cooling component in the circulating cooling module to cool the circulating water to reduce the water temperature at the water inlet, thereby helping to ensure the circulating cooling of the entire optical path coupling system 100.

In some embodiments, the optical path coupling system 100 is further provided with a humidity sensor 137 electrically connected to the monitoring control module 190. The humidity sensor 137 is located in the optical path switching module 130, and is configured to monitor the humidity in the optical path switching module 130, and transmit the monitored humidity signal to the monitoring control module 190. During the use of the optical path coupling system 100, when the humidity signal received by the monitoring control module 190 exceeds the preset humidity threshold, the monitoring control module 190 can control the optical path switching module 130 to perform dehumidification processing to avoid excessive humidity in the optical path switching module 130, which may affect the transmission of the laser beam and the coupling efficiency in the optical path coupling module 140, thereby ensuring the normal use of the entire optical path coupling system 100.

It should be noted that the various signals received by the monitoring control module 190 of the optical path coupling system 100 in the embodiments of the present application communicate with the host computer using the CAN industrial bus to facilitate the integrated design of the optical path coupling system 100, thereby improving the adaptability of the optical path coupling system 100.

Secondly, an embodiment of the present application further provides a control method for an optical path coupling system. The optical path coupling system includes a laser input optical fiber, and an optical path switching module and an optical path coupling module arranged in sequence along the transmission path of the laser input optical fiber. The optical path switching module includes an optical path switching assembly and a first photoelectric sensor. The optical path coupling module includes a coupling assembly and a second photoelectric sensor. The optical path coupling system further includes a monitoring control module, which is electrically connected to the optical path switching assembly, the first photoelectric sensor and the second photoelectric sensor. The specific structure of the optical path coupling system can be referred to the relevant description of the above embodiments, and will not be described in detail here.

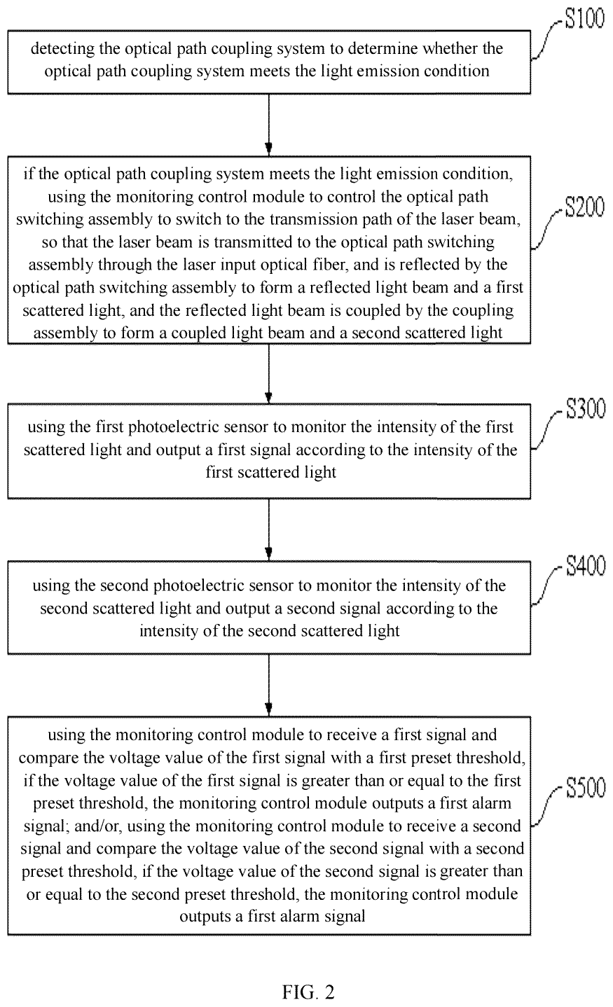

FIG. 2 is a flow chart of a control method for an optical path coupling system according to an embodiment of the present application. As shown in FIG. 2, the control method for the optical path coupling system mainly includes the following steps:

S100, detecting the optical path coupling system 100 to determine whether the optical path coupling system 100 meets the light emission condition.

Before using the optical path coupling system 100, it is necessary to perform a self-check on the optical path coupling system 100 to determine whether the optical path coupling system 100 meets the light emission condition, so as to avoid safety hazards such as light leakage caused by directly activating the optical path coupling system 100.

The detection of the optical path coupling system 100 mainly includes: using the first contact sensor 123 to detect whether the laser input optical fiber 110 is correctly connected, using the second contact sensor 143 to detect whether the laser output optical fiber 150 is correctly connected, using the control switch 162 to detect whether the operation chamber 161 is correctly closed, and the like; when the monitoring control module 190 receives the monitoring signals output by the first contact sensor 123, the second contact sensor 143 and the control switch 162, it indicates that the optical path coupling system 100 preliminarily meets the light emission condition and can proceed to the next step of operation.

S200, if the optical path coupling system 100 meets the light emission condition, using the monitoring control module 190 to control the optical path switching assembly 131 to switch to the transmission path of the laser beam, so that the laser beam is transmitted to the optical path switching assembly 131 through the laser input optical fiber 110, and is reflected by the optical path switching assembly 131 to form a reflected light beam and a first scattered light, and the reflected light beam is coupled by the coupling assembly 141 to form a coupled light beam and a second scattered light.

After determining that the optical path coupling system 100 meets the light emission condition, according to the selected target operation chamber 161 and the corresponding optical path, the optical path switching assembly 131 is controlled by the monitoring control module 190 to switch to the transmission path of the laser beam, so that the laser beam is transmitted to the optical path switching assembly 131 through the laser input optical fiber 110, and is reflected by the optical path switching assembly 131 to form a reflected light beam and a first scattered light, and the reflected light beam is coupled by the coupling assembly 141 to form a coupled light beam and a second scattered light.

When the monitoring control module 190 controls the optical path switching assembly 131 to switch to the transmission path of the laser beam, it is necessary to first detect whether the rotatable reflector 132 of the optical path switching assembly 131 is rotated to the target position according to the corresponding position sensor 136. If the rotatable reflector 132 is not rotated to the target position, it means that the optical path coupling system 100 still does not meet the light emission condition at this time, and the corresponding optical path switching assembly 131 needs to be checked and adjusted until the rotatable reflector 132 rotates to the target position before light emission is allowed.

S300, using the first photoelectric sensor 135 to monitor the intensity of the first scattered light and output a first signal according to the intensity of the first scattered light.

During actual use, due to the influence of the processing technology of the rotatable reflector 132 or the damage of the rotatable reflector 132 due to long-term use, the laser beam may generate a first scattered light when it is reflected by the rotatable reflector 132, thereby reducing the final coupling efficiency of the laser beam. Moreover, the first scattered light generated will also cause damage to other components in the optical path switching assembly 131, affecting the service life of the entire optical path coupling system 100.

By using the first photoelectric sensor 135 to monitor the intensity of the first scattered light, the damage condition of the rotatable reflector 132 can be reversely indicated. The greater the intensity of the first scattered light, the more serious the damage to the rotatable reflector 132. The first photoelectric sensor 135 can output a corresponding first signal according to the intensity of the first scattered light, so as to timely replace or adjust the rotatable reflector 132 to ensure the normal use of the optical path coupling system 100 and improve the service life of the optical path coupling system 100.

S400, using the second photoelectric sensor 142 to monitor the intensity of the second scattered light and output a second signal according to the intensity of the second scattered light.

During actual use, due to the influence of the coupling lens processing technology or the damage of the coupling lens due to long-term use, the reflected light beam may generate second scattered light after being coupled by the coupling lens, thereby reducing the final coupling efficiency of the laser beam. Moreover, the second scattered light generated will also cause damage to other components in the coupling assembly 141, affecting the service life of the entire optical path coupling system 100.

By using the second photoelectric sensor 142 to monitor the intensity of the second scattered light, the damage of the coupling lens can be reversely indicated. The greater the intensity of the second scattered light, the more serious the damage of the coupling lens. The second photoelectric sensor 142 can output a corresponding second signal according to the intensity of the second scattered light, so as to replace or adjust the coupling lens in time to ensure the normal use of the optical path coupling system 100 and improve the service life of the optical path coupling system 100.

S500, using the monitoring control module 190 to receive a first signal and compare the voltage value of the first signal with a first preset threshold, if the voltage value of the first signal is greater than or equal to the first preset threshold, the monitoring control module 190 outputs a first alarm signal; and/or, using the monitoring control module 190 to receive a second signal and compare the voltage value of the second signal with a second preset threshold, if the voltage value of the second signal is greater than or equal to the second preset threshold, the monitoring control module 190 outputs a first alarm signal.

Specifically, the first photoelectric sensor 135 and the second photoelectric sensor 142 are configured to monitor the intensity of the first scattered light and the second scattered light, respectively, and convert the intensity of the first scattered light and the intensity of the second scattered light into voltage signals respectively, and then output the corresponding voltage signals as the first signal and the second signal to the monitoring control module 190. The monitoring control module 190 can receive the first signal and the second signal, and output a first alarm signal according to the first signal and/or the second signal and the set determination condition.

By providing a first photoelectric sensor 135 in the optical path switching module 130 and a second photoelectric sensor 142 in the optical path coupling module 140, the monitoring control module 190 can output an alarm signal based on one or both of the first signal and the second signal, thereby helping to improve safety monitoring in the optical path coupling system 100 and enhance the safety of the optical path coupling system 100.

In some embodiments, the first signal is received by the monitoring control module 190, and the voltage value of the first signal is compared with a first preset threshold. If the voltage value of the first signal is greater than or equal to the first preset threshold, the monitoring control module 190 outputs a first alarm signal. Since the first signal directly reflects the scattering of the laser beam reflected by the rotatable reflector 132, the monitoring control module 190 outputs a first alarm signal as long as the voltage value of the first signal is greater than or equal to the first preset threshold, thereby stopping the output of the laser beam.

In other embodiments, the monitoring control module 190 is con used to receive the second signal and compare the voltage value of the second signal with a second preset threshold. If the voltage value of the second signal is greater than or equal to the second preset threshold, the monitoring control module 190 outputs a first alarm signal.

During the use of the optical path coupling system 100, in addition to the scattered light generated by the coupling assembly 141 itself, the retro-reflected light which is generated due to reflection from the surface of the processed workpiece and enters the coupling cylinder when the coupled light beam is transmitted to the surface of the workpiece through the laser output optical fiber 150 will also be monitored by the second photoelectric sensor 142 as part of the second scattered light. That is to say, the generation of retro-reflected light will increase the intensity of the second scattered light monitored by the second photoelectric sensor 142, but in this case, the increased intensity of the second scattered light cannot directly indicate that the coupling efficiency of the optical path coupling system 100 has been significantly reduced. Therefore, when setting the second preset threshold, the second preset threshold can be set to be greater than the first preset threshold to reduce the impact of the generation of back reflection light on the accuracy of the first alarm signal output by the monitoring control module 190.

It should be noted that when the processed workpiece does not produce obvious retro-reflected light, that is, when the second scattered light is mainly generated by the coupling assembly 141 itself, the second preset threshold can be set to be equal to the first preset threshold, so that the monitoring control module 190 can output the first alarm signal in time, thereby stopping the output of the laser beam. That is to say, the magnitude relationship between the second preset threshold and the first preset threshold can be adjusted accordingly according to the actual use of the optical path coupling system 100, and no special limitation is made here.

The first preset threshold can be set to be less than or equal to 2.0V; the second preset threshold can be set to be greater than or equal to 2.5V and less than or equal to 3.0V. Specifically, the first preset threshold can be set to 2.0V, 1.8V, 1.6V or 1.5V, etc.; the second preset threshold can be set to 2.5V, 2.6V, 2.8V or 3.0V, etc. The corresponding specific values can be selected according to the actual use of the optical path coupling system 100, and no special restrictions are made here.

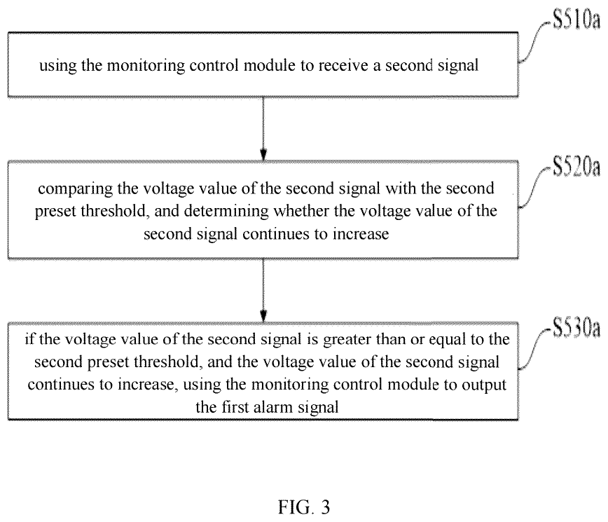

In some embodiments, as shown in FIG. 3, to improve the accuracy of the first alarm signal output by the optical path coupling system 100, step S500 in the embodiment of the present application may include the following contents:

S510a, using the monitoring control module 190 to receive a second signal;

S520a: comparing the voltage value of the second signal with the second preset threshold, and determining whether the voltage value of the second signal continues to increase;

S530a: if the voltage value of the second signal is greater than or equal to the second preset threshold, and the voltage value of the second signal continues to increase, using the monitoring control module 190 to output the first alarm signal.

Specifically, the second signal is received by the monitoring control module 190, and when the voltage value of the second signal is greater than or equal to the second preset threshold, and the voltage value of the second signal continues to increase, the monitoring control module 190 outputs the first alarm signal. That is to say, when the monitoring control module 190 outputs the first alarm signal, it needs to simultaneously determine whether the voltage value of the second signal is greater than or equal to the second preset threshold, and whether the voltage value of the second signal is continuously increasing.

During the use of the optical path coupling system 100, the coupled light beam may be reflected on the surface of the workpiece to generate retro-reflected light and enter the coupling cylinder. The generation of retro-reflected light will increase the intensity of the second scattered light monitored by the second photoelectric sensor 142, causing the voltage value of the second signal to be greater than or equal to the second preset threshold. However, the intensity of the reflected light generated on the workpiece surface during the machining process is not stable, which causes the voltage value of the second signal to fluctuate.

In the case that the second scattered light detected by the second photoelectric sensor 142 is mainly caused by damage to the coupling lens itself, since the damage is irreversible and the second scattered light will cause further damage to the coupling lens, the intensity of the second scattered light will further increase, thereby causing the voltage value of the second signal to continue to increase. By combining the voltage value of the second signal and the growth pattern of the voltage value of the second signal to determine whether the coupling efficiency of the optical path coupling system 100 decreases, the accuracy of the first alarm signal output by the monitoring control module 190 can be improved, thereby improving the stability of the optical path coupling system 100 during use.

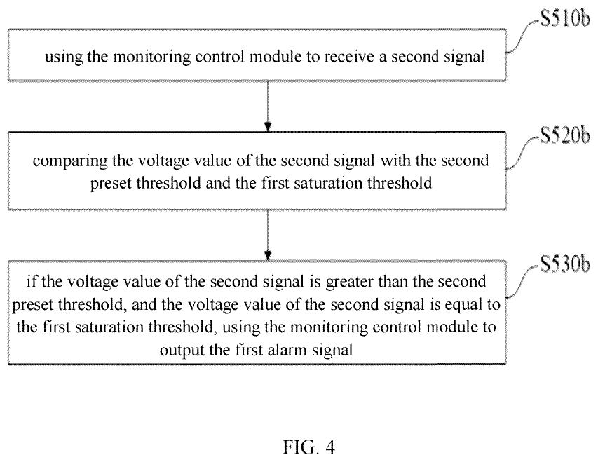

In other embodiments, as shown in FIG. 4, to further improve the accuracy of the first alarm signal output by the optical path coupling system 100, step S500 in the embodiment of the present application may further include the following contents:

S510b, using the monitoring control module 190 to receive a second signal;

S520b, comparing the voltage value of the second signal with the second preset threshold and the first saturation threshold;

S530b: if the voltage value of the second signal is greater than the second preset threshold, and the voltage value of the second signal is equal to the first saturation threshold, using the monitoring control module 190 to output the first alarm signal.

Specifically, the monitoring control module 190 is used to receive the second signal and compare the voltage value of the second signal with the second preset threshold and the first saturation threshold. When the voltage value of the second signal is greater than the second preset threshold and the voltage value of the second signal is equal to the first saturation threshold, the monitoring control module 190 outputs a first alarm signal.

When the second scattered light detected by the second photoelectric sensor 142 is mainly caused by damage to the coupling lens itself, the continuous increase in the intensity of the second scattered light may cause the voltage value of the second signal to rapidly increase to the first saturation threshold in a short time. In this case, if the monitoring control module 190 cannot determine whether the voltage value of the second signal is continuously increasing or fluctuating, it can output a first alarm signal based on the voltage value of the second signal reaching the first saturation threshold, so as to achieve safety monitoring of the optical path coupling system 100, thereby improving the safety of the optical path coupling system 100 during use.

It should be noted that if the intensity of the second scattered light generated by the coupling lens itself is small, but the reflection of the coupled light beam by the workpiece surface is strong, so that the intensity of the retro-reflected light generated is large, the voltage value of the second signal exceeds the second preset threshold and reaches the second saturation threshold, and remains at the second saturation threshold, wherein the second saturation threshold is less than the first saturation threshold. In this case, the monitoring control module 190 will not output the first alarm signal.

Since the coupled light beam will experience certain losses after being reflected on the workpiece surface, the intensity of the retro-reflected light generated is lower than the intensity of the coupled light beam. Compared with the scattered light directly generated by the coupled light beam, the voltage value of the second signal corresponding to the retro-reflected light is smaller, so that the second saturation threshold to which the voltage value of the second signal caused by the retro-reflected light reaches is lower than the first saturation threshold to which the voltage value of the second signal caused by the scattered light reaches.

That is to say, when the voltage value of the second signal of the optical path coupling system 100 reaches saturation due to the coupling lens itself, its saturation value is the first saturation threshold, and the monitoring control module 190 will output the first alarm signal; and when the voltage value of the second signal of the optical path coupling system 100 reaches saturation due to retro reflection, its saturation value is the second saturation threshold, and the monitoring control module 190 will not output the first alarm signal.

Optionally, in the optical path coupling system 100, the monitoring control module 190 can further be used to receive a third signal output by the third photoelectric sensor 122 in the shaping module 120, and compare the voltage value of the third signal with a third preset threshold. When the voltage value of the third signal is greater than or equal to the third preset threshold, the monitoring control module 190 outputs a first alarm signal. Since the third signal directly reflects the scattering of the laser beam shaped by the shaping component 121 in the shaping module 120, as long as the voltage value of the third signal is greater than or equal to the third preset threshold, the monitoring control module 190 outputs the first alarm signal and stops the output of the laser beam.

The retro-reflected light generated on the surface of the workpiece will not be transmitted to the third photoelectric sensor 122, that is, the retro-reflected light will not affect the voltage value of the third signal. Therefore, when setting the third preset threshold, the third preset threshold can be set to be smaller than the second preset threshold to ensure the accuracy of the first alarm signal output by the monitoring control module 190. Since the retro-reflected light generated by the workpiece surface will not be transmitted to the first photoelectric sensor 135, when setting the third preset threshold, the third preset threshold can be set to be equal to the first preset threshold.

In some embodiments, during the light emitting process of the optical path coupling system 100, if the operation chamber 161 is opened, that is, the corresponding control switch 162 is turned off, and the monitoring control module 190 cannot receive the fourth signal output by the control switch 162 in real time, the laser beam will also be turned off immediately to ensure the safety of the optical path coupling system 100 and the operator.

In other embodiments, the monitoring control module 190 can also use the temperature sensor 181 to monitor the temperature of the absorber 180. During the light emission process of the optical path coupling system 100, if the rotatable reflector 132 is damaged and causes the optical path to change, the laser beam will be directly emitted to the absorber 180. The absorber 180 can absorb the laser beam and the temperature will gradually increase. The temperature sensor 181 is configured to monitor the temperature of the absorber 180 and transmit the monitored temperature information to the monitoring control module 190. When the temperature information received by the monitoring control module 190 reaches a preset temperature threshold, the monitoring control module 190 outputs a second alarm signal and immediately cuts off the light output to ensure the safety of the optical path coupling system 100.

The above is a detailed introduction to an optical path coupling system and a control method for an optical path coupling system according to an embodiment of the present application. Specific examples are used herein to illustrate the principles and implementation methods of the present application. The description of the above embodiments is only used to help understand the method of the present application and its core idea. For those skilled in the art, according to the idea of the present application, there will be changes in the specific implementation method and application scope. In summary, the content of this specification should not be understood as a limitation on the present application.

1. An optical path coupling system, comprising:
a laser input optical fiber, configured to transmit a laser beam;
an optical path switching module, located in an output optical path of the laser beam; wherein the optical path switching module comprises an optical path switching assembly and at least one first photoelectric sensor, and wherein the optical path switching assembly is configured to reflect the laser beam to form a reflected light beam and a first scattered light, the at least one first photoelectric sensor is configured to monitor an intensity of the first scattered light and output a first signal according to the intensity of the first scattered light;
an optical path coupling module, located in an output optical path of the reflected light beam; wherein the optical path coupling module comprises a coupling assembly and a second photoelectric sensor, and wherein the coupling assembly is configured to couple the reflected light beam to form a coupled light beam and a second scattered light, the second photoelectric sensor is configured to monitor an intensity of the second scattered light and output a second signal according to the intensity of the second scattered light; and
a monitoring control module, electrically connected to the at least one first photoelectric sensor and the second photoelectric sensor; wherein the monitoring control module is configured to receive the first signal and the second signal and output a first alarm signal according to at least one of the first signal and the second signal.

2. The optical path coupling system according to claim 1, wherein the monitoring control module is configured to receive the first signal and compare a voltage value of the first signal with a first preset threshold, and when the voltage value of the first signal is greater than or equal to the first preset threshold, the monitoring control module outputs the first alarm signal; and/or,
wherein the monitoring control module is configured to receive the second signal and compare a voltage value of the second signal with a second preset threshold, and when the voltage value of the second signal is greater than or equal to the second preset threshold, the monitoring control module outputs the first alarm signal;
wherein the second preset threshold is greater than or equal to the first preset threshold.

3. The optical path coupling system according to claim 2, wherein the monitoring control module is used to receive the second signal, and when the voltage value of the second signal is greater than or equal to the second preset threshold, and the voltage value of the second signal continues to increase, the monitoring control module outputs the first alarm signal.

4. The optical path coupling system according to claim 2, wherein the monitoring control module is configured to receive the second signal and compare the voltage value of the second signal with a first saturation threshold, and when the voltage value of the second signal is equal to the first saturation threshold, the monitoring control module outputs the first alarm signal; wherein the first saturation threshold is greater than the second preset threshold.

5. The optical path coupling system according to claim 2, wherein the first preset threshold is less than or equal to 2.0V; and the second preset threshold is greater than or equal to 2.5V and less than or equal to 3.0V.

6. The optical path coupling system according to claim 1, wherein the optical path switching assembly comprises a plurality of rotatable reflectors and a plurality of rotating adjustment components, wherein the plurality of rotatable reflectors are sequentially arranged along the output optical path of the laser beam, and the rotating adjustment components are each connected to one of the rotatable reflectors to rotate the corresponding rotatable reflector into or out of the output optical path of the laser beam.

7. The optical path coupling system according to claim 6, wherein each of the rotatable reflectors is provided with one of the at least one first photoelectric sensor to monitor the intensity of the first scattered light generated after the laser beam is reflected by a corresponding one of the rotatable reflectors.

8. The optical path coupling system according to claim 2, further comprising a shaping module located between the laser input optical fiber and the optical path switching module; the shaping module comprising a shaping component and a third photoelectric sensor, wherein the laser beam is shaped by the shaping component to form a shaped beam and a third scattered light, and the third photoelectric sensor is configured to monitor an intensity of the third scattered light and output a third signal according to the intensity of the third scattered light; the monitoring control module is electrically connected to the third photoelectric sensor, and the monitoring control module is configured to receive the third signal and output the first alarm signal according to the third signal.

9. The optical path coupling system according to claim 8, wherein the shaping component comprises-one or more at least one of a collimating lens, a beam expander lens and a shaping lens.

10. The optical path coupling system according to claim 8, wherein the monitoring control module is configured to receive the third signal and compare a voltage value of the third signal with a third preset threshold, and when the voltage value of the third signal is greater than or equal to the third preset threshold, the monitoring control module outputs the first alarm signal; wherein the third preset threshold is less than or equal to the second preset threshold.

11. The optical path coupling system according to claim 10, wherein the third preset threshold is less than or equal to 2.0V.

12. The optical path coupling system according to claim 1, wherein further comprising:
a laser output optical fiber, located in an output optical path of the coupled light beam;
an operation module, located in an output optical path of the laser output optical fiber, wherein the coupled light beam is to be transmitted to the operation module through the laser output optical fiber; the operation module comprises a control switch configured to output a fourth signal; the monitoring control module is electrically connected to the control switch and configured to receive the fourth signal and control an emission of the laser beam according to the fourth signal.

13. The optical path coupling system according to claim 12, comprising a first contact sensor and a second contact sensor, wherein the first contact sensor is configured to monitor whether the laser input optical fiber is correctly connected and a temperature of the laser input optical fiber, and the second contact sensor is configured to monitor whether the laser output optical fiber is correctly connected and a temperature of the laser output optical fiber; the monitoring control module is electrically connected to the first contact sensor and the second contact sensor, and the monitoring control module is configured to receive monitoring signals of the first contact sensor and the second contact sensor and control the emission of the laser beam according to the monitoring signals.

14. The optical path coupling system according to claim 6, comprising an absorber arranged in parallel with the plurality of rotatable reflectors and configured to absorb the laser beam.

15. The optical path coupling system according to claim 14, wherein a temperature sensor is provided on the absorber, and the temperature sensor is configured to monitor a temperature of the absorber and output a temperature signal; the monitoring control module is electrically connected to the temperature sensor and configured to receive the temperature signal and output a second alarm signal according to the temperature signal.

16. The optical path coupling system according to claim 1, comprising a circulating cooling module, on which a flow rate and temperature sensor is provided, wherein the flow rate and temperature sensor is configured to monitor a flow rate and temperature of water at an inlet of the circulating cooling module, the monitoring control module is electrically connected to the flow rate and temperature sensor, the monitoring control module is configured to receive a monitoring signal of the flow rate and temperature sensor and control the circulating cooling module to cool circulating water according to the monitoring signal.

17. The optical path coupling system according to claim 1, wherein further comprising a humidity sensor located in the optical path switching module, wherein the humidity sensor is configured to monitor a humidity in the optical path switching module and output a humidity signal, wherein the monitoring control module is electrically connected to the humidity sensor and configured to receive the humidity signal and control the optical path switching module to perform dehumidification processing according to the humidity signal.

18. A control method for an optical path coupling system, wherein the optical path coupling system comprises a laser input optical fiber, and an optical path switching module and an optical path coupling module sequentially arranged along a transmission path of the laser input optical fiber; the optical path switching module comprising an optical path switching assembly and a first photoelectric sensor, the optical path coupling module comprising a coupling assembly and a second photoelectric sensor, the optical path coupling system further comprising a monitoring control module electrically connected to the optical path switching assembly, the first photoelectric sensor and the second photoelectric sensor; wherein the control method comprises:
detecting the optical path coupling system to determine whether the optical path coupling system meets a light emission condition;
if the optical path coupling system meets the light emission condition, using the monitoring control module to control the optical path switching assembly to switch to a transmission path of a laser beam, so that the laser beam is transmitted to the optical path switching assembly through the laser input optical fiber, and is reflected by the optical path switching assembly to form a reflected beam and a first scattered light, and the reflected beam is coupled by the coupling assembly to form a coupled beam and a second scattered light;
using the first photoelectric sensor to monitor an intensity of the first scattered light and output a first signal according to the intensity of the first scattered light;
using the second photoelectric sensor to monitor an intensity of the second scattered light and output a second signal according to the intensity of the second scattered light;
using the monitoring control module to perform at least one of steps of:
receiving the first signal and comparing a voltage value of the first signal with a first preset threshold; if the voltage value of the first signal is greater than or equal to the first preset threshold, the monitoring control module outputs a first alarm signal; and
receiving the second signal and comparing a voltage value of the second signal with a second preset threshold; if the voltage value of the second signal is greater than or equal to the second preset threshold, the monitoring control module outputs a first alarm signal.

19. The control method for the optical path coupling system according to claim 18, wherein under a condition that the monitoring control module is used to perform the step of receiving the second signal and comparing a voltage value of the second signal with a second preset threshold, the step comprises:
using the monitoring control module to receive the second signal;
comparing the voltage value of the second signal with the second preset threshold, and determining whether the voltage value of the second signal continues to increase;
if the voltage value of the second signal is greater than or equal to the second preset threshold, and the voltage value of the second signal continues to increase, using the monitoring control module to output the first alarm.

20. The control method for the optical path coupling system according to claim 18, wherein under a condition that the monitoring control module is used to perform the step of receiving the second signal and comparing a voltage value of the second signal with a second preset threshold, the step comprises:
using the monitoring control module to receive the second signal;
comparing the voltage value of the second signal with the second preset threshold and a first saturation threshold;
if the voltage value of the second signal is greater than the second preset threshold, and the voltage value of the second signal is equal to the first saturation threshold, using the monitoring control module to output the first alarm.
